(19) United States
(12) Patent Application Publication
(10) Pub. No.: US 2010/0108715 A1
(43) Pub. Date: May 6, 2010

(54) DISPENSING DEVICE, RECEPTACLE FOR SAID DEVICE AND CORRESPONDING SYSTEM FOR PREPARING A DRINK

(76) Inventor: Stefano Santagiuliana, Caldogno (VI) (IT)

Correspondence Address: BIRCH STEWART KOLASCH & BIRCH, PO BOX 747, FALLS CHURCH, VA, 22040-0747, US

(21) Appl. No.: 12/523,137

(22) PCT Filed: Feb. 4, 2008
(86) PCT No.: PCT/IB08/00298

§ 371 Date: Jul. 14, 2009

(30) Foreign Application Priority Data
Feb. 6, 2007 (IT) VI2007A000036

(51) Int. Cl. B67D 7/06; B65D 41/04; B67D 7/74; B67D 7/78

(52) U.S. Cl. 222/81; 220/288; 222/145.1; 222/325; 206/219

(57) ABSTRACT

The present invention concerns a dispensing device (1, 100, 200, 300) to be applied to a container (501), comprising a cap (120) suited to open/close a duct (111, 140). Said device also comprises: a housing suited to accommodate a preferably removable receptacle (1, 1a, 1b, 1c, 1d) containing a substance (S2); breaking means (102) suited to break the receptacle (1, 1a, 1b, 1c, 1d) to release the substance (S2, S3), said breaking means (102) being able to be activated by the user through manoeuvring means (103). The invention also concerns a receptacle and a system for preparing a drink.

The invention concerns a dispensing device, a receptacle or capsule for said device and a system for preparing a drink that can be obtained by mixing at least two substances.

In particular, the present invention concerns a system for preparing a drink that is obtained by mixing a concentrated substance, contained in a receptacle that is also the subject of the invention, with a generally liquid product placed in a container, as well as a corresponding dispensing device that makes it possible both to take the product and/or release said substance into the container and to take the mixture obtained by combining said product and said substance.

As is known, especially in the world of sports, special drinks are widespread that contain aromatising and/or replenishing substances and/or mineral salts and that athletes use before, after or during their sporting performances.

Said drinks are generally sold in canteens provided with closing devices and/or caps of the push-pull type.

These push-pull dispensing and closing devices substantially comprise a threaded ring nut suited to be coupled with the neck of the canteen and provided with a closing element that is applied in such a way as to be able to be moved with respect to the ring nut, in order to assume a closing position and an opening position, respectively.

More precisely, said element, in the above mentioned opening/closing positions, opens/closes a duct through which the product can flow out of the container.

To extract the product, therefore, the user arranges the closing element in the open position and lets out the product.

Some particular embodiments of these devices are constructed in such a way as to allow the user to open and close the container even without using his/her hands, by simply grasping the closing element with his/her teeth.

A first drawback noticed by the consumers of these aromatised and/or replenishing drinks lies in that these drinks are not always available in the places where one would like to take them. This means that the consumers cannot choose their drink near the place where they want to take it and when they want to take it. A further drawback lies in that said consumers, even when they succeed in finding a place where to buy drinks of this type, cannot always have the drink they wish to consume. In fact, the points of sale don't generally offer all the aromatised and/or replenishing drinks present on the market, as they tend to limit their offer to products of a given type in order to maximise sales and reduce purchasing costs.

Another, yet not the least drawback is represented by the fact that, in order to guarantee their effectiveness, some of said drinks must be produced at the moment of consumption, and therefore cannot be prepared in advance and kept in containers ready for use.

The object of the present invention is to overcome all the drawbacks described. In particular, it is a first object of the invention to construct a dispensing device, a receptacle or capsule for said device and a system for preparing a drink that can be obtained by mixing at least two substances.

It is another object of the invention to construct a device and a system that allow the user to choose, and if necessary to prepare, according to the need, the product to which he/she will add the aromatising and/or replenishing substance when he/she wishes.

It is a further object of the invention to construct a device and a system that allow the user to directly drink the liquid product present in the container or to prepare in advance and then consume the aromatised drink obtained by mixing the product and the aromatising and/or replenishing substance. In other words, it is another object of the invention to construct a system and a device that allow the user to drink the liquid product without necessarily mixing it with the substance contained in the device, and that, if required, allow said substance to be released, mixed with the liquid product and successively consumed.

It is a further object of the invention to construct a device that can be removed from the container of the liquid product, in order to allow the product to be successively topped up and/or replaced according to the need.

It is another object of the invention to construct a device and a system that make it possible to prepare an aromatised/replenishing drink with characteristics and qualities determined in advance.

It is a further object of the invention to construct a device that can be applied to a container and also serves for closing said container.

It is a further object of the invention to construct a device that can substantially be applied to any container.

It is a further object of the invention to construct a device that allows the user to choose the substance to be added to and mixed with the liquid product at the moment of use.

It is a further object of the invention to construct a reusable device.

It is a further object of the invention to construct a system, a device and a receptacle that are simple to make and require a reduced number of parts.

It is another object of the invention to construct a system, a capsule and a device that are reliable and easy to assemble.

It is another object of the invention to construct a system and a device that can be activated without the aid of the hands, and in particular that can be activated simply, even with the aid of the mouth or teeth.

It is another, yet not the least object of the invention to construct a mixing system and a device that allow the user to choose the aromatised drink.

The objects described above are achieved by a dispensing device, a receptacle or capsule for said device and a system for preparing a drink that can be obtained by mixing at least two substances, characterized in the respective independent claims.

Advantageous embodiments of the invention are the subject of the dependent claims.

To advantage, the proposed solution also allows the consumer to drink the product from the container without mixing the aromatising/replenishing substance therein.

According to a preferred embodiment of the invention, the device assumes the function of a device of the push-pull type that allows the intake of the liquid product or of the drink obtained by mixing the liquid product with a substance containing, for example, mineral salts.

Advantageously, the proposed solution also allows any type of container, like for example a normal water bottle, to be transformed into a canteen provided with a system for preparing aromatised and/or replenishing drinks.

Still advantageously, the proposed solution also allows the capsule or receptacle to be replaced, thus making the device and the system reusable.

Still advantageously, the proposed solution is particularly versatile, in fact it allows the container, the device and the receptacle to be sold/purchased separately, with evident economic and commercial advantages.

The aims and advantages described above will be highlighted in greater detail in the description of some preferred embodiments of the invention, supplied as examples without limitation, with reference to the attached drawings, wherein:

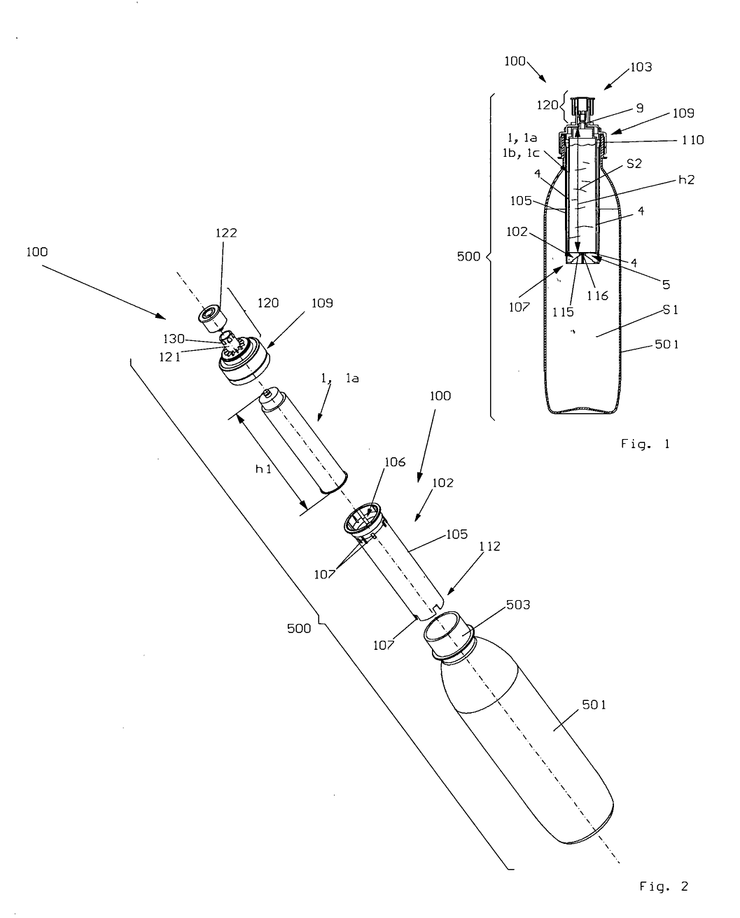

FIG. 1 shows a longitudinal cross section of a system carried out according to the invention, comprising a device and a receptacle that are also the subject of the invention;

FIG. 2 shows an axonometric exploded view of the system of FIG. 1;

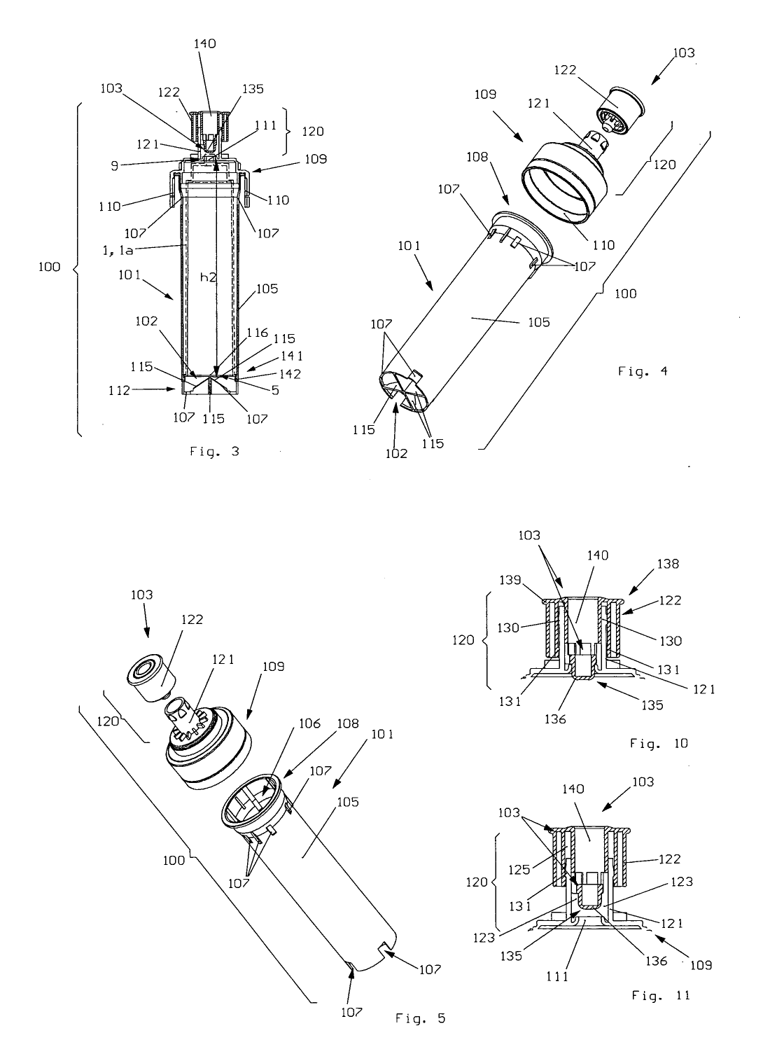

FIG. 3 shows a longitudinal cross section of the device carried out according to the invention shown in FIG. 1;

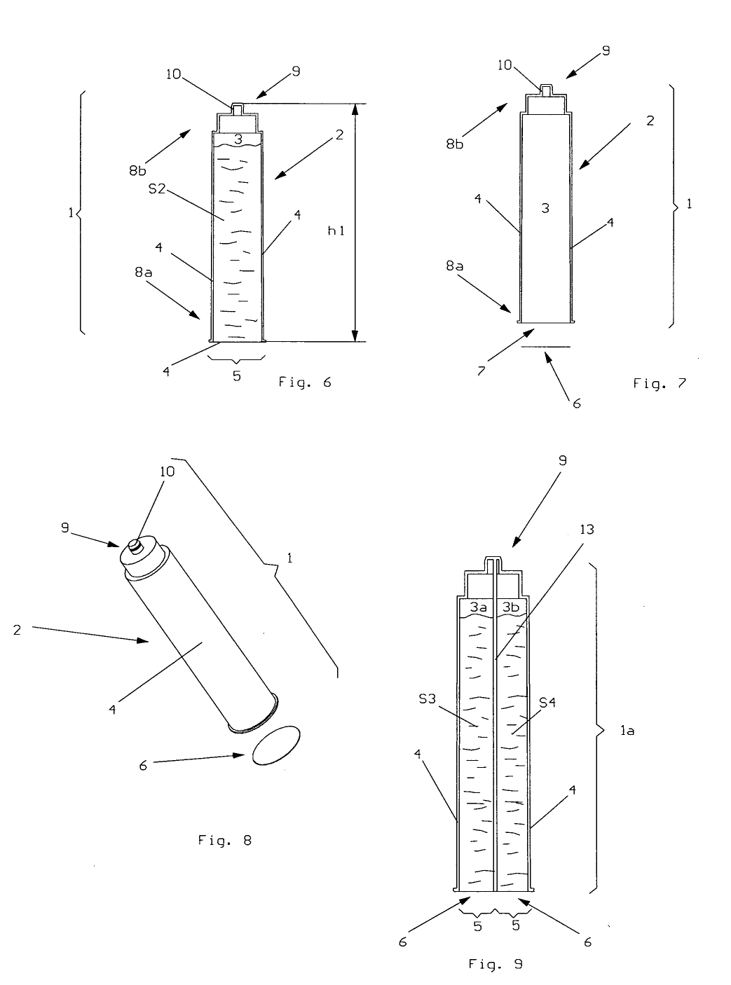

FIGS. 4 and 5 show two axonometric exploded views of the device shown in FIG. 3;

FIG. 6 shows a longitudinal cross section of the receptacle or capsule shown in FIG. 1;

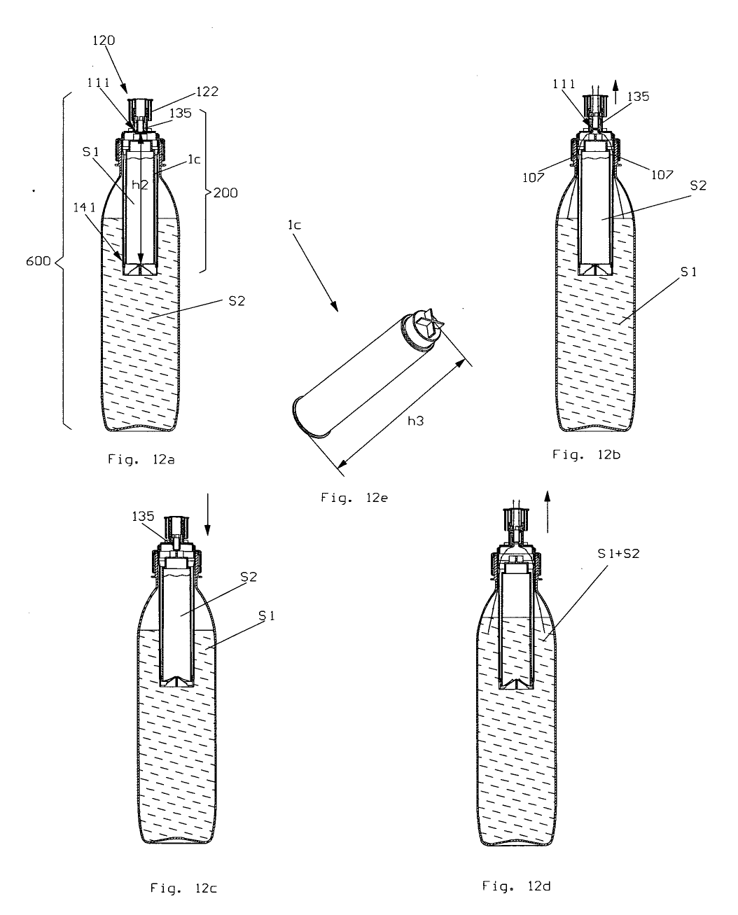

FIG. 7 shows a longitudinal cross-section and exploded view of the receptacle or capsule shown in FIG. 6;

FIG. 8 shows an axonometric exploded view of the receptacle shown in FIG. 6;

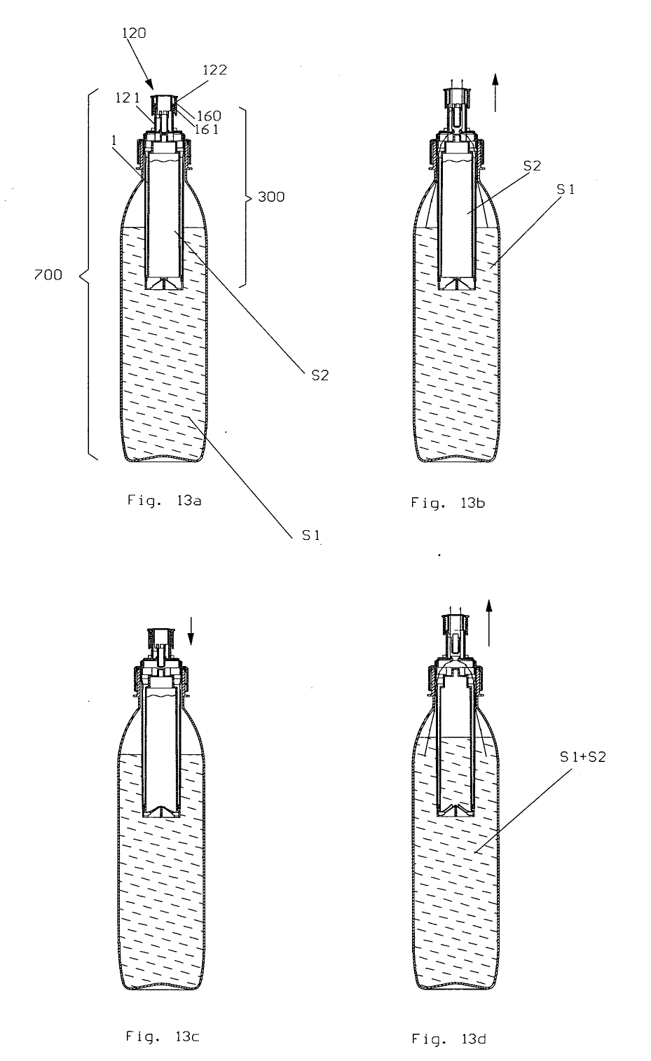

FIG. 9 shows a longitudinal cross section of another example of a receptacle or capsule carried out according to the invention;

FIG. 10 shows a longitudinal cross section of a part of the device of FIG. 3 in a particular operating configuration;

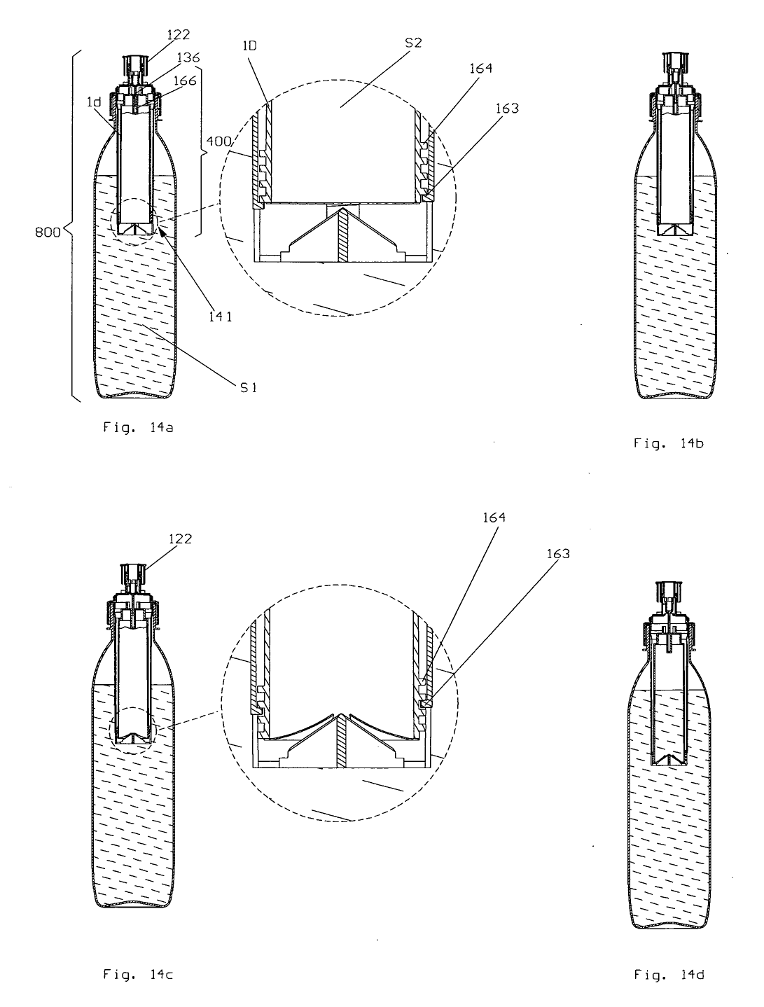

FIG. 11 shows a longitudinal cross section of the same part of the device of FIG. 3 shown in FIG. 10, but in a different operating configuration;

Figures from 12a to 12d show longitudinal cross-section views of another example of a system carried out according to the invention, comprising a device and a receptacle, which are also the subject of the invention, in different operating positions;

FIG. 12e shows a perspective view of the receptacle included in the system of FIG. 12a;

Figures from 13a to 13d show longitudinal cross-section views of a further example of a system carried out according to the invention, comprising a device and a receptacle, which are also the subject of the invention, in different operating positions;

Figures from 14a to 14d show longitudinal cross-section views of another example of a system carried out according to the invention, comprising a device and a receptacle, which are also the subject of the invention, in different operating positions;

Figures from 15 to 19 show longitudinal cross-section views of the possible configurations of the system of FIG. 1 during the various usage steps;

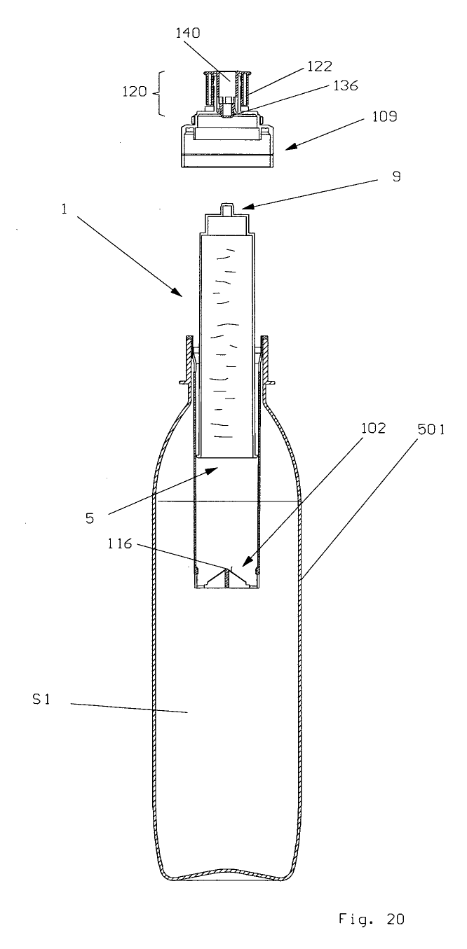

FIG. 20 shows a stage in the assembly of the system shown in FIG. 1.

By way of introduction it is important to point out that the same components in different examples of embodiments are indicated by the same reference numbers. The position indications given in the different examples of embodiment should be transferred to the new position.

A system for preparing a drink that can be obtained by mixing at least two substances S1 and S2, object of the present invention, is represented in FIGS. 1 and 2, where it is indicated as a whole by 500.

This system comprises a container 501 containing at least one of the above mentioned substances S1 and a dispensing device indicated as a whole by 100, which is also the subject of the invention and is shown in particular in FIGS. 3, 4 and 5, provided with means 110 for connection to the mouth 503 of the container 501.

According to the invention, the system 500 also comprises a capsule or receptacle 1 for at least another of said substances S2 that is also the subject of the invention and is shown in detail in FIGS. 6, 7 and 8.

In particular, said capsule 1 comprises a hollow body 2 defining a volume 3 suited to contain the substance S2, in which it is possible to identify, in at least one of its walls 4, at least one controlled yielding area 5 suited to allow the wall 4 in said area 5 to be broken when a force exceeding a given value is exerted on the same area 5.

In particular, said minimum force must exceed the force that is accidentally exerted on the walls of the receptacle 1, for example during the storage and transport of the same.

In the example of embodiment represented herein the hollow body 2 comprises a tubular body with substantially circular cross section and the yielding area is defined by a thin sheet 6 made of aluminium and extruded polyethylene or aluminium and extruded polypropylene, which closes at least one opening 7 present on the hollow body 2.

In other applications that require the presence of a wording on said thin sheet to indicate the type of substance contained in the capsule or any other information, to make the thin sheet it is possible to use multiple combined materials like polyethylene/aluminium/extruded polyethylene or polyethylene/aluminium/extruded polypropylene.

More precisely, the yielding area 5 is arranged at the level of the bottom 8a of the body 2 and the thin sheet or seal 6 is applied to the body 2 through adhesive means and in particular through a bonding agent.

In other embodiments of the invention the thin sheet 6 is applied to the body 2 in a different way, for example through a heat-sealing process.

It is clear, however, that the body 2 may have any shape and that the opening 7 and/or the yielding area 5 may have any shape and dimensions.

It should also be noted, as will be better explained below, that the opening 7, shown in detail in FIG. 7, also allows the introduction of the substance S2 into the body 2 during preparation of the capsule 1.

It is clear, however, that the introduction of the substance S2 in the volume 3 may also take place through other openings, successively closed, temporarily obtained for this purpose in the body 2.

The capsule or receptacle 1 is also provided with a closing element 9 that is also suited, as will be explained in greater detail below, to cooperate with the device 100 described below.

In the particular embodiment of the invention illustrated herein, said closing element 9 is arranged at the level of the upper part 8b of the body 2 and comprises an element 10 that projects from the external surface of the body 2 and has a substantially cylindrical shape.

Another embodiment of the capsule of the invention not represented herein differs from the previous one due to the fact that the yielding area is obtained by thinning the walls 4 of the hollow body, which, for example, can be obtained by moulding a plastic material.

In other embodiments, the introduction of the substance may take place for example through at least one special opening closed by a cap that if necessary can be removable.

A further construction variant of the capsule of the invention, indicated as a whole by 1a in FIG. 9, differs from the previous ones due to the fact that the receptacle is divided by a diaphragm 13 in two volumes or compartments 3a and 3b, each suited to contain a corresponding substance S3 and S4 and provided with at least one corresponding yielding area 5 in some areas of the respective external walls.

As regards the dispensing device 100, shown in particular in Figures from 3 to 5, it also allows the release of a substance into a container, as will be better illustrated below.

Said device can be applied to a container and comprises a cap 120 suited to open/close a dispensing duct 140.

According to the invention, it also comprises:
a housing suited to accommodate at least one preferably removable receptacle 1, 1a containing at least one substance S2;
breaking means 102 suited to break at least part of one wall of said at least one receptacle 1a in order to release said substance S2, said breaking means 102 being able to be activated by the user through manoeuvring means 103.

In the preferred non-limiting embodiment of the invention illustrated herein, the housing is defined by a support element 101 suited to support at least one receptacle or capsule 1, represented with a broken line in FIG. 3, which preferably and in the example shown is of the type described above and more precisely of the type indicated by 1, 1a in the Figures from 6 to 9.

The manoeuvring means 103 can be activated by the user and are suited to act on the receptacle 1 to activate said breaking means 102 and break at least part of a wall of the receptacle 1 and/or on the support 101 to make at least one opening through which the substance S2 can consequently flow out.

More precisely, said manoeuvring means 103 act on the receptacle 1 to mutually move the device 100 and the capsule 1 and force at least part of the walls of the latter against the breaking means 102 to create, as will be better explained below, said opening through which the substance S2 can flow out of the receptacle 1c.

In particular, said breaking means 102 are integral with the support element 101 and are arranged so that, during the operation stage carried out using the manoeuvring means 103, they can act on the walls of the receptacle 1, 1a at the level of the yielding areas 5 with which the receptacle 1, 1a is preferably provided, as described above.

It is clear, however, that in other embodiments of the invention said yielding areas 5 may substantially comprise even all the walls of the receptacle, which means that the receptacle may have only some reinforced areas at the level, for example, of the points of interaction with the manoeuvring means 103.

In the embodiment of the invention represented in FIGS. 3 and 4 the support element 101 comprises a tubular element 105 provided with an upper opening 106 visible in particular in FIG. 5 that, as will be clearer below, allows the receptacle 1, 1a to be inserted/extracted in/from the housing in the device 100, as well as with side openings 107 for the passage of the substance S1 and of the drink obtained by mixing the substances S1 and S2.

Said element 101 is also provided in its upper part with means 108 for coupling to a ring nut 109, the latter being provided with means 110 for fixing to the neck 503 of the container 501 visible in particular in FIG. 4.

The ring nut 109 also presents a passage duct 111, visible in FIGS. 3 and 11, through which, as will be explained more clearly below, the mixed product flows out of the container 501.

It should also be observed that, as will be described in greater detail below, the cross section of the passage duct 111 substantially coincides with the cross section of the closing element 9 of the receptacle 1c described above and that the height h1 of the receptacle 1, compared to the height of the housing suited to accommodate the receptacle itself, is such as to allow the closing element 9 to engage with the duct 111.

More particularly, the height h1 of the receptacle is greater than the distance h2 between the beginning of the duct 111 and the temporary support means 141 of the capsule 1, which will be described more clearly below.

This advantageously allows the closing element 9 to engage in a tight manner with the duct 111, as shown in particular in FIG. 1, thus temporarily preventing the passage of the substance S1 before the operation of the breaking means 102 of the device 100.

As to the coupling means 108, they are preferably of the snap type, even if they may assume a different configuration, and they comprise an annular projection that is visible in particular in FIG. 5 and is suited to be coupled with a corresponding seat present in the ring nut 109.

This advantageously allows the user or the manufacturer, as will be explained in greater detail below, to insert the receptacle 1c in the tubular element 105 through the opening 106.

As to the fixing means 110, visible in FIG. 4, in the non-limiting example represented herein they comprise a threaded edge suited to be coupled with a corresponding thread present on the neck 503 of the container 501. It is clear that also these fixing means may assume a different shape suitable, in any case, to allow the device 100 to be applied to the container 501.

As to the breaking means 102, they are arranged, as previously described, near and/or at the level of the weak areas 5 preferably present in the receptacle 1, 1a, and therefore in particular, in the example represented herein, at the level of the bottom 112 of the tubular element 105.

They preferably comprise a projection 115, preferably provided with at least one sharp end 116, visible in particular in FIG. 3, suited to cut the wall of the receptacle 1, 1a.

In other embodiments of the invention, not illustrated herein, said means 102 comprise a plurality of sharp teeth directed towards the inside of the volume defined by the support element 105 suited to accommodate the capsule 1, 1a; more generally said teeth may have any other shape suited to perform the function described.

As to the closing cap 120, shown in detail in FIGS. 10 and 11, it is arranged downstream of the passage duct 111 that communicates with the dispensing duct 140.

In the example represented herein, said closing cap 120 is of the push-pull type and comprises a first element or collar 121 defining the above mentioned dispensing duct 140, also called the outlet mouth of the device 100, integral with the ring nut 109 to which a closing element or cap 122 is applied in a removable manner with respect to the first element 121 in order to be able to assume respectively a closing position, shown in detail in FIG. 10, and an opening position, shown in FIG. 11, where the device places the inside of the container to which it is applied in communication with the outside.

More precisely, said closing element 122, moving from the above mentioned opening/closing positions, opens/closes an outlet duct 123, defined by the walls of the second element 122 and by the walls of the collar 121. Said duct 123 communicates with the passage duct 111 and with the outlet mouth 140, through which the drink can flow out of the container 501.

The closing element 122 is also provided with first guide elements 125 suited to be coupled with second guide elements integral with the collar 121 that guide its movement.

More precisely, said first guide elements 125 comprise an annular seat suited to house the second guide elements defined, in the example represented herein, by the wall of the collar 121 itself.

The device 100 also comprises means suited to limit the movement of said closing element 120 and to prevent it from coming off the collar 121. In the preferred embodiment of the invention represented herein said means comprise a first annular projection 130 integral with the collar 121 and a second annular projection 131 created on the closing element 120, visible in detail in FIG. 10. The closing element 120 is also provided, as is shown more clearly in FIGS. 10 and 11, a shutter element 135 that, as will be explained in greater detail below, is suitable for closing the passage duct 111 when the device 100 has been activated and the cap 120 is in the closed position.

More precisely, said shutter element 135, in the preferred non-limiting embodiment of the invention illustrated herein, comprises a shaped body 136 whose profile matches the profile of the passage duct 111, said shaped body 136 being in particular substantially cylindrical in shape, with diameter substantially equal to the diameter of the passage duct 111.

The closing element 120 is also provided with means 138 suited to make it easier for the user to grasp it and move it in the open/closed positions described above. In the particular non-limiting embodiment of the invention illustrated herein, said means 138 comprise an external annular projection 139 that forms a shoulder suitable for exerting the traction/thrusting force necessary to open/close the push-pull cap.

As regards the manoeuvring means 103, in the particular embodiment of the invention represented herein they belong to said closing cap and are obtained on the closing element 102 itself. More precisely, they comprise the above mentioned shutter element 135 that, as will be better explained below, acts on the capsule 1.

It should be observed, furthermore, that the device 100 also comprises the already mentioned temporary support means 141 for the capsule 1 comprising, in the embodiment represented herein, an annular support edge 142, visible in particular in FIG. 3 projecting from the inner surface of the tubular element 105 and forming a temporary support shoulder for the capsule 1 visible also in FIG. 1. More precisely, said means 141 are suited to temporary support the capsule 1 when it is inserted in the tubular element 105 to prevent any accidental contact between the breaking means 102 and the yielding area 5 facing it. This advantageously makes it possible to avoid the accidental opening of the capsule 1, for example during the storage and/or transport of the device 100 that accommodates the capsule 1 itself.

It is clear that in other solutions these support means 140 may have a different configuration and a different shape, provided that it is suitable for performing the function described above.

According to a further embodiment of the invention not illustrated herein, the manoeuvring means 103 that the user utilises to break the cartridge comprise a ring nut or another element not necessarily belonging to the push-pull cap.

It must also be observed that the tubular element, as well as the capsule, can also be made from a transparent material, in order to advantageously allow the consumer to identify, for example through the particular colour of the substance S2 contained in the receptacle, the characteristics of the product that will be obtained by mixing the substance S2 with the substance S1 contained in the container.

As an alternative, the same tubular element may be provided with openings or windows to allow a visual check of the type and conditions of the capsule housed therein.

The operation of the invention will now be described in greater detail, making reference to the system 500 shown in FIG. 1, comprising a capsule or receptacle of the type shown in FIG. 6 and a device of the type shown in FIG. 3.

As regards the preparation of the receptacle or capsule 1, it is worth emphasising that, once the volume has been filled with the substance S2, the capsule 1 is closed, substantially in a tight manner, by applying the seal by means of a bonding agent or an adhesive or heat sealing techniques. This operation is generally carried out at the plant where the capsules are produced.

Once the capsule 1 containing the desired substance S2 has been selected, for the assembly of the device the capsule is placed inside the support element 105 through the opening 106, as shown in particular in FIG. 20, and successively the support element 105 is coupled to the ring nut 109.

In this regard it is important to point out that in this stage the closing element 9 is coupled with the connection duct 111 and closes it.

Successively, the device 100 complete with the capsule 1 is anchored to the container 501, screwing the ring nut 109 to the neck 503 of the container and obtaining the configuration shown in FIG. 15.

It should be observed that these assembly operations can be performed also by the user who, therefore, once having purchased the capsules containing the desired substances, will be able to choose the drink that he/she intends to consume at the moment of and in the place of consumption.

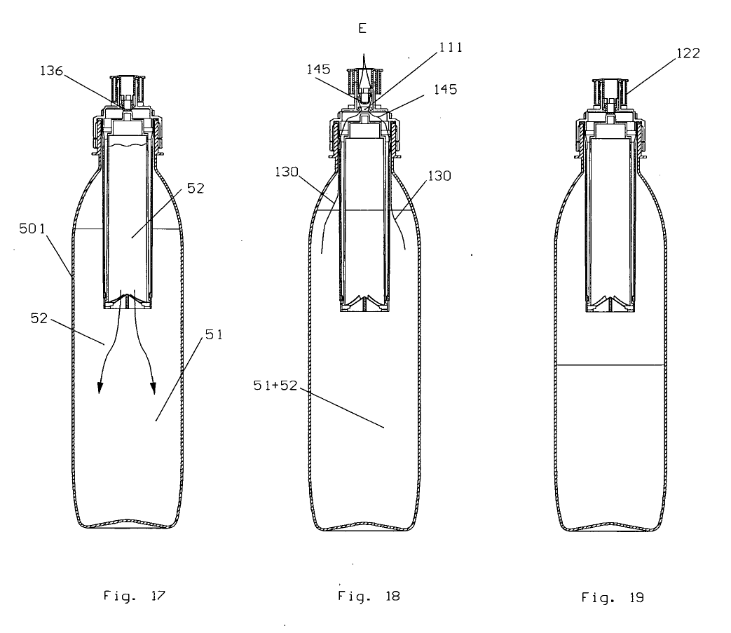

To activate the system 500 that, as explained above, appears as shown in detail in FIG. 15, the user removes the protection element 508 as shown in FIG. 16 and acts on the device 100. More precisely, he/she proceeds using the manoeuvring means 103 and more particularly moves the closing element 122 shifting it downwards. This places the shutter element 136 in contact with the closing element 9 of the cartridge 1, thus causing it to move downwards.

This places the surface of the receptacle 1 and in particular the yielding area 5 in contact with the breaking means 102. The user continues the operation and breaks the wall 4 in said area 5, as shown in detail in FIG. 17, thus releasing the substance S2 that falls into the container 501 and is mixed with the substance S1. In this situation, in fact, the movement of the closing element 122 of the cap 120 generates a mutual movement between the means 102 suited to break the walls 4 and the receptacle 1, thus breaking the wall 4 itself.

It must be observed that in this situation the cap 120 is in the closing position and the user can thus advantageously shake the container to facilitate the mixing of the substances S1, S2 without causing them to flow out of the container 501.

Once the drink has been prepared, to extract the product the user places the closing element 122 in the open position and pours the product. More precisely, he opens the cap by acting on the closing element 122 and moves it upwards in the open position, as shown in detail in FIG. 18.

In this way, the shutter element 136 disengages from the connection duct 111, creating a passage that is indicated by number 145 in FIG. 18 and that, through the openings 107, places the inside of the container 501 in communication with the external environment E.

After consuming the drink, the user can close the container 501 by moving the closing element 122 downwards.

In this way, the element 136 is engaged again in the connection duct 111, closing it and preventing the drink from flowing out.

It should be observed that, advantageously, both the device and the system proposed can be assembled directly by the consumer or be assembled in the production plant and be sold ready for use.

It should also be observed that the receptacle 1, once its wall has been broken, remains in that position.

This is ensured both by the breaking means 102 that penetrate the walls 4 and by the temporary support means 141.

As to the substances S1 and S2, it is clear that they can be of any nature and type and in particular be indifferently liquid or solid substances.

A construction variant of the system and the device of the invention, indicated as a whole and respectively by numbers 600 and 200 in the Figures from 12a to 12d differs from the previous one owing to the fact that it makes it possible to take the product S1 also without mixing it with the substance S2 contained in the receptacle 1c.

More particularly, in the example represented herein this is obtained due to the special shape of the capsule 1c, shown in FIG. 12e.

More precisely, in the particular non-limiting embodiment of the invention illustrated herein, the height h3 of the receptacle 1 is inferior to the distance h2 between the beginning of the duct 111 and the temporary support means 141 for the capsule 1c.

In this case, the duct 111 is closed by the closing element 122 and in particular by the shutter element 135, as shown in detail in FIG. 12a.

The cap 120 can assume at least three positions that are respectively shown in FIGS. 12a, 12b and 12c. A first closing position is shown in FIG. 12a, where the shutter element 135 closes the duct 111, thus preventing the substance and/or the drink from flowing out of the container.

A second opening position is shown in detail in FIG. 12b, where the shutter element 135 disengages from the duct 111, thus allowing the product or the drink to flow out of the container through the slits 107 present in the tubular element 105.

A third position is shown in detail in FIG. 12c, where the shutter element 135 activates the breaking means 102 and opens the capsule to allow the substance S2 to be mixed with the product S1. Successively, the user can move the cap to the first position in order to take the substance mixed with the product, as shown in detail in FIG. 12d.

A further construction variant of the system and of the device of the invention, indicated as a whole and respectively by numbers 700 and 300 in the Figures from 13a to 13d, with the capsule 1, differs from the previous one owing to the fact that the cap 120 is not of the push-pull type. In particular, in this embodiment of the invention the cap 120 consists of a screw cap in which the closing element 122 is provided with a threading 160 suited to be coupled with a threading 161 created on the collar 121.

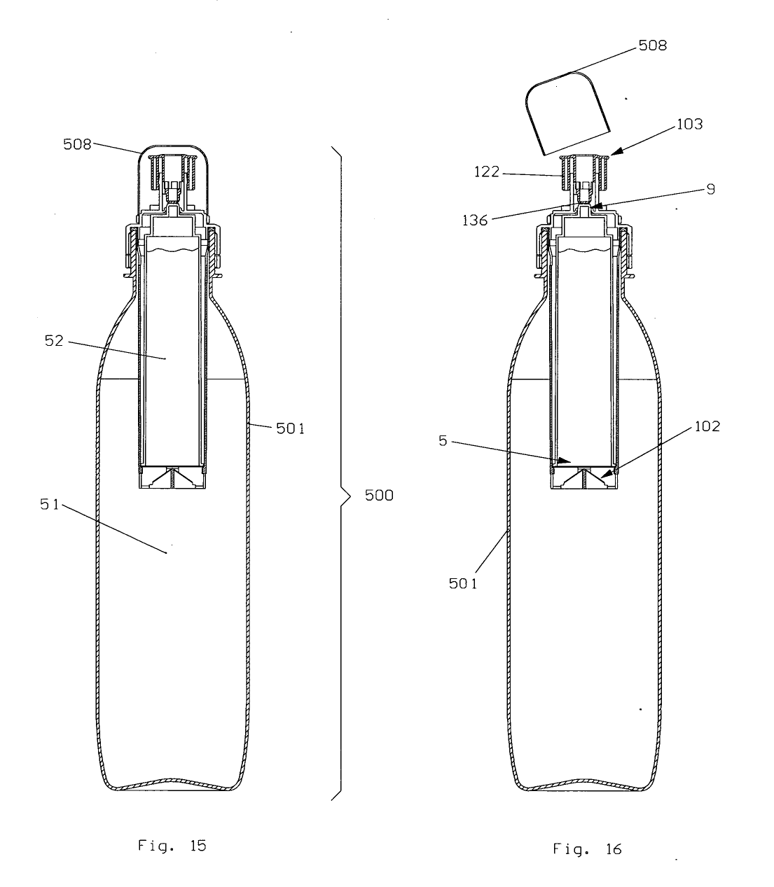

A further construction variant of the system and of the device of the invention, indicated as a whole and respectively by numbers 800 and 400 in the Figures from 14a to 14d, with a different capsule indicated as a whole by 1d, differs from the previous one owing to the fact that the temporary support means 141 comprise a first thread 163 suited to be coupled with a corresponding thread 164 created on the capsule 1d, as shown in the details of FIGS. 14a and 14c.

According to this solution, the shaped body 136 has a flattened shape suited to fit in a corresponding seat 166 created in the upper part of the capsule 1d.

It is clear, however, that in other solutions the seat may be obtained in the element of the cap and that the shaped body may belong to the capsule 1d.

In this case the user, when he/she intends to mix the substance S2 with the product S1, rotates the closing element 122, thus also causing the rotation of the capsule 1d that, thanks to the presence of the thread, will lower until breaking the closing seal as shown in FIG. 14c. Successively, to be able to drink the solution the user must simply rotate the closing element in the opposite direction, until opening the cap as shown in FIG. 14d. It should also be observed that when the closing element 122 is set rotating in one direction, it involves in its rotation the capsule 1d that lowers down due to the presence of the thread with which it engages, while, when the closing element 122 is set rotating in the opposite direction, it opens the dispensing duct. It is clear that this solution can be applied also to caps of the push-pull type. In this latter case, instead of the thread it is preferable to use recesses with which the closing element 122 engages.

The above description clearly shows that the solution proposed allows the drawbacks described to be eliminated.

It is important to point out that, to advantage, the proposed solution with the push-pull cap is particularly simple and compact and makes it possible, through the activation of the push-pull cap, both to break some parts of the walls of the capsule and to close/open the container 501 before or after the release of the substance in the container.

This also allows the user to open and close the container even without using his/her hands, by simply grasping the closing element, that is, the manoeuvring means, with his/her teeth.

Still advantageously, it is worth noting that in the same particular embodiment proposed with push-pull cap, a single element, that is, the closing element 122, ensures both the tightness and the breakage of the capsule, which are achieved simply by moving the element itself in its open/closed positions. This advantageously makes it possible to reduce the number of components of the device/system, simplifying its construction and reducing its costs.

In the embodiment of the invention illustrated herein said mutual movement is a linear movement and in particular it develops along a direction that is substantially orthogonal to the bottom of the container. According to other embodiments of the invention, said movement can for example be a rotary movement, as described above.

To advantage, the proposed solution allows also the user to change the capsule, as well as to remove the device from the container, and thus to choose the substances S1 and S2 that he/she wishes to mix to prepare the desired drink.

It should also be observed that according to the system proposed only the capsule must be of the disposable type.

In this regard it is important to point out the capsule may advantageously be made from a recyclable material, like for example a plastic and/or synthetic and/or metallic material and if necessary collected in order to fill it again.

It should also be observed that by properly dimensioning the ring nut 109 it is possible to obtain a device that can be associable with any container available on the market, thus advantageously increasing the versatility of the device itself.

It should also be observed that the proposed solution advantageously makes it possible to produce capsules, devices and systems that can even be assembled automatically, directly in the production lines.

Although the invention has been described with reference to the attached drawings, it may undergo modifications in subsequent stages of its implementation that shall all come within the scope of the invention expressed in the following claims and shall consequently be covered by the present patent.

1-32. (canceled)

33. Dispensing device (1, 100, 200, 300) adapted to be applied to a container (501), said device comprising a closing cap (120) with a first element (121) associated with a closing element (122) installed in a movable manner with respect to said first element (121), in order to be able to assume at least one opening position and at least one closing position so as to open/close a duct (111, 140), respectively, said device further comprising a housing (105) accommodating at least one removable receptacle (1, 1a, 1b, 1c, 1d) containing a substance (S2);
breaking means (102) suited to break said at least one receptacle (1, 1a, 1b, 1c, 1d) in order to release said substance (S2),
characterized in that said closing element (122) comprises manoeuvring means (103) suited to act on said receptacle (1, 1a, 1b, 1c, 1d) to reciprocally move said receptacle with respect to said device (1, 1a, 1b, 1c, 1d) in order to force at least part of the walls of said receptacle against said breaking means (102) and obtain at least one opening through which said at least one substance (S2) can flow out when said closing element is moved to said closing position; in that said housing (105) is removably fixed to said closing cap (120) so as to allow said receptacle to be introduced into and removed from said housing (105); and in that said manoeuvring means (103) comprises a shutter element (135) integral with said closing element (122) and adapted to close/open said duct (11, 140) once said at least one substance (S2) is flowed out from said receptacle.

34. Device according to claim 33, characterized in that said housing comprises at least one support element (101) suited to support said at least one receptacle (1, 1a, 1b, 1c).

35. Device according to claim 34, characterized in that said support element is provided with at least one opening (107) for the passage of said at least one substance (S1).

36. Device according to claim 34, characterized in that said support element is provided with at least one opening (106) for the introduction and/or extraction of said at least one receptacle (1c).

37. Device according to claim 34, characterized in that said at least one support element (101) comprises a tubular element (105).

38. Device according to claim 34, characterized in that said at least one support element, in at least some of its parts, is transparent or presents openings that ensure visual access.

39. Device according to claim 34, characterized in that said breaking means (102) are integral with said support element (101) and are arranged so that, during the operation stage carried out with the manoeuvring means (103), they act on the walls of the receptacle (1, 1a, 1b, 1c, 1d) at the level of at least one yielding area (5) provided on the latter.

40. Device according to claim 33, characterized in that said breaking means (102) comprise at least one projection (115) provided with at least one sharp end (116) or a plurality of sharp teeth.

41. Device according to claim 33, characterized in that said closing cap (120) is of the push-pull type.

42. Device according to claim 40, characterized in that said closing cap (120) is of the screw type and in that said closing element (121) is provided with a thread suited to match a thread present on a collar integral with a ring nut for fixing to the neck of said container.

43. Device according to claim 33, characterized in that said device can assume at least three operating positions, one opening position suited to place the inside of the container to which it is applied in communication with the outside along with said one closing position and one open position suited to activate said breaking means.

44. Device according to claim 33, characterized in that it also comprises temporary support means (141) for said at least one receptacle, said support means being suited to prevent any accidental contact between said breaking means (102) and the walls of said receptacle.

45. Device according to claim 44, characterized in that said temporary support means of said at least one receptacle comprise an annular support edge (142) or at least one thread suited to engage with a second thread belonging to said at least one receptacle.

46. Device according to claim 33, characterized in that the distance between said breaking means and said at least one passage duct (111) exceeds the height (h2) of said at least one receptacle.

47. System (500, 600, 700) for preparing a substance by mixing at least two substance (S1) and (S2), said system comprising a container (501) containing at least one substance (S1), characterized in that it also comprises a dispensing device according to claim 33, along with a receptacle containing said second substance (S2) and accommodated in said housing (105) of said device.

48. Device according to claim 35, characterized in that said at least one support element (101) comprises a tubular element (105).

49. Device according to claim 36, characterized in that said at least one support element (101) comprises a tubular element (105).

50. Device according to claim 35, characterized in that said at least one support element, in at least some of its parts, is transparent or presents openings that ensure visual access.

51. Device according to claim 36, characterized in that said at least one support element, in at least some of its parts, is transparent or presents openings that ensure visual access.

52. Device according to claim 37, characterized in that said at least one support element, in at least some of its parts, is transparent or presents openings that ensure visual access.
